(19) United States
(12) Patent Application Publication
(10) Pub. No.: US 2022/0235871 A1
(43) Pub. Date: Jul. 28, 2022

(54) ROUGH-IN VALVE ASSEMBLY AND FLUSH PLUG

(71) Applicant: AS America, Inc., Piscataway, NJ (US)

(72) Inventors: Hsiao Chang Li, Edison, NJ (US); Walter Pitsch, Washington, NJ (US)

(73) Assignee: AS America, Inc., Piscataway, NJ (US)

(21) Appl. No.: 17/612,858

(22) PCT Filed: Jun. 10, 2020
(86) PCT No.: PCT/US2020/036981

§ 371 Date: Nov. 19, 2021

Related U.S. Application Data
(60) Provisional application No. 62/859,756, filed on Jun. 11, 2019.
(60) Provisional application No. 62/862,803, filed on Jun. 18, 2019.

(51) Int. Cl. F16K 11/085; E03C 1/04

(52) U.S. Cl. CPC F16K 11/0853; E03C 2001/026; E03C 1/0403

(57) ABSTRACT

A flush plug for a rough-in valve, wherein the flush plug is configured to be removably disposed in a rough-in valve chamber, and comprises an inlet/outlet pair defining a flow passageway, wherein when disposed in the rough-in valve chamber, in a first flush plug position, the flow passageway is configured to provide flow communication between a first fluid source and a first plumbing outlet, and in a second flush plug position, the flow passageway is configured to provide flow communication between a second fluid source and the first plumbing outlet; and wherein the first fluid source and the second fluid source are not in flow communication.

The disclosure is directed to a rough-in valve and a valve flush plug configured to be removably disposed in the rough-in valve.

### BACKGROUND

Upon installation of a rough-in valve for a tub/shower combination, and prior to installation of a mixing valve in the rough-in valve, water supply lines may be run with a flush plug in place to clean debris from the lines, valve and outlets and to ensure they are performing properly. Large projects including hotels, apartment buildings, and the like require installation of a large number of valves for shower/tub combinations. In some situations, a plurality of valves, supply lines and outlets may be flushed simultaneously. Isolation of hot and cold water lines during a flush process would provide a more efficient flushing process and help identify and locate any problems.

### SUMMARY

Accordingly, disclosed is a flush plug for a rough-in valve, wherein the flush plug is configured to be removably disposed in a rough-in valve chamber, and comprises an inlet/outlet pair defining a flow passageway, wherein when disposed in the rough-in valve chamber, in a first flush plug position, the flow passageway is configured to provide flow communication between a first fluid source and a first plumbing outlet, in a second flush plug position, the flow passageway is configured to provide flow communication between a second fluid source and the first plumbing outlet, and the first fluid source and the second fluid source are not in flow communication.

In an embodiment, the second flush plug position relative to the first flush plug position is about a 90 degree rotation interval of the flush plug relative to the rough-in valve chamber.

Also disclosed is a flush plug as disclosed herein, comprising a first inlet/outlet pair defining a first flow passageway; and a second inlet/outlet pair defining a second flow passageway; wherein in the first flush plug position, the first flow passageway is configured to provide flow communication between the first fluid source and the first plumbing outlet, and the second flow passageway is configured to be a dead-end or is configured to provide flow communication between the second fluid source and a second plumbing outlet; in the second flush plug position, the first flow passageway is configured to provide flow communication between the second fluid source and the first plumbing outlet, and the second flow passageway is configured to be a dead-end or is configured to provide flow communication between the first fluid source and the second plumbing outlet; and wherein the first and second flow passageways are isolated.

Also disclosed is a rough-in valve assembly comprising a rough-in valve having a chamber configured to receive a valve manifold or a flush plug; a first valve inlet configured to be in flow communication with a first fluid source; a second valve inlet configured to be in flow communication with a second fluid source; a first valve outlet configured to be in flow communication with the valve chamber and a first plumbing outlet; and the flush plug as disclosed herein removably disposed in the chamber.

Also disclosed is a plumbing system comprising first and second rough-in valve assemblies as disclosed herein, wherein one of the rough-in valves is rotated about 180 degrees about a Y axis in order to position the two rough-in valves back-to-back, and wherein the two rough-in valves are configured to receive the first fluid source from the same side and configured to receive the second fluid source from the same side, and the flush plug of the second rough-in valve assembly is positioned at about a 90 degree rotation interval relative to the flush plug of the first rough-in valve assembly.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 depicts a rough-in valve according to an embodiment.

FIG. 2A displays a flush plug according to an embodiment.

FIG. 2B shows a cross-section view of a flush plug portion according to an embodiment.

FIG. 3A depicts an assembly comprising a flush plug disposed in a rough-in valve, according to an embodiment.

FIG. 3B shows a front perspective cross-section view of a flush plug disposed in a rough-in valve (rough-in valve/flush plug assembly), according to an embodiment.

FIG. 4A shows a front, perspective view of a flush plug/rough-in valve assembly, according to an embodiment.

FIG. 4B displays a flush plug, according to an embodiment.

FIG. 4C shows a front, perspective cross-section view of a flush plug/rough-in valve assembly, according to an embodiment.

FIG. 5A and FIG. 5B depict a cross-section view of a flush plug portion and a front perspective cross-section view of a flush plug/rough-in valve assembly, respectively, according to an embodiment.

### DETAILED DISCLOSURE

A rough-in valve is a valve used in plumbing systems to connect one or more fluid inlets to one or more fluid outlets. It would be highly convenient for plumbers to install a rough-in valve and to flush it and test it with a flush plug in place, and wherein hot and cold water lines are isolated. If hot and cold water cross flow is prevented, flushing of debris would be more efficient and any problems would be more easily identified. This is also the case wherein a plurality of rough-in valves are flushed and tested simultaneously.

In an embodiment, a rough-in valve is configured to receive a manifold, a manifold/fluid mixing valve assembly, or a present flush plug. A fluid mixing valve may be for instance a pressure balance valve or a thermostatic valve. A fluid mixing valve may comprise an adjustable limiter, designed to limit an amount (e.g. percentage) of hot water allowed to flow through the valve. The fluid mixing valve may have an inlet dedicated for hot water and an inlet dedicated for cold water.

In an embodiment, a valve manifold comprises first and second inlets and first and second outlets. Likewise, a flush plug of the invention comprises a first inlet and a first outlet (a first inlet/outlet pair) and a second inlet and second outlet (second inlet/outlet pair).

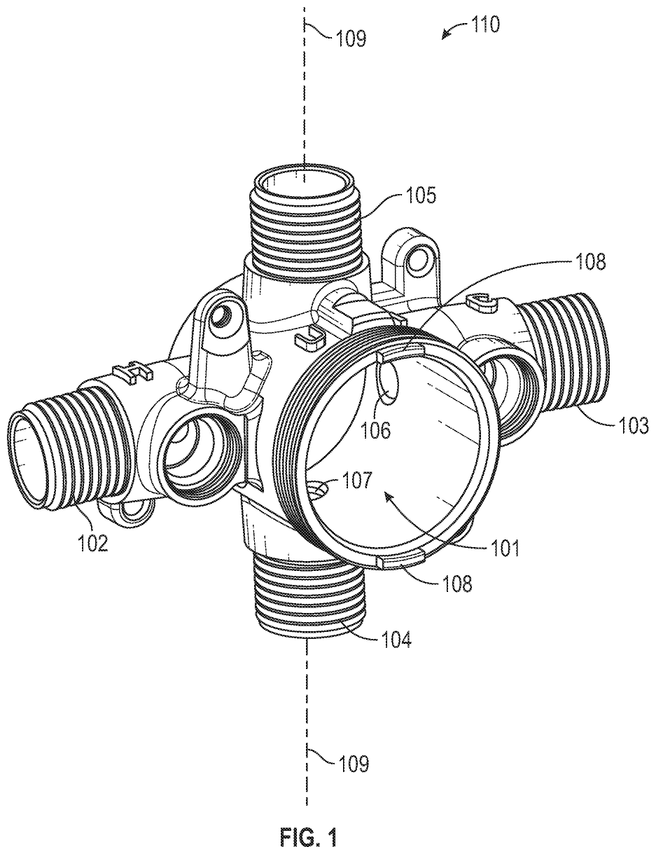

FIG. 1 shows a front perspective view of rough-in valve 110 according to an embodiment having valve chamber 101 configured to receive a valve manifold or a flush plug. Rough-in valve 110 comprises first inlet 102 and second inlet 103 configured to be in flow communication with a hot water source and a cold water source. Rough-in valve 110 comprises first outlet 104 configured to be in flow communication with a first plumbing outlet, for instance a bathtub outlet. Rough-in valve 110 comprises second outlet 105 configured to be in flow communication with a second plumbing outlet, for instance a shower outlet. Visible is one of the inlet passageways 106 and one of the outlet passageways 107. Tabs 108 are configured to mate with slots on a flush plug to properly position the flush plug. Dashed line 109 represents a Y axis of rough-in valve 110.

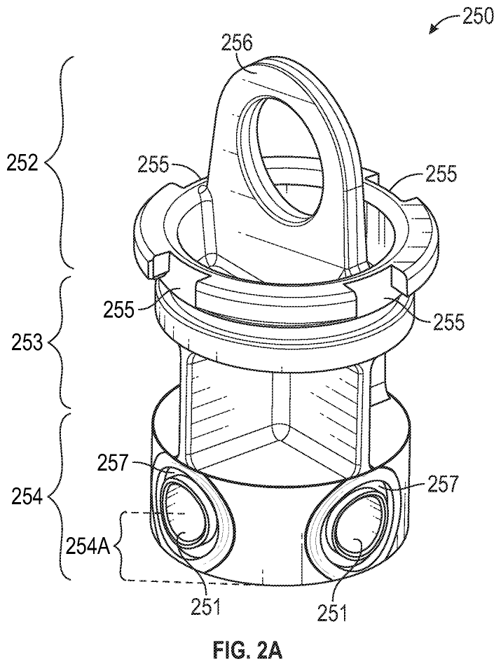

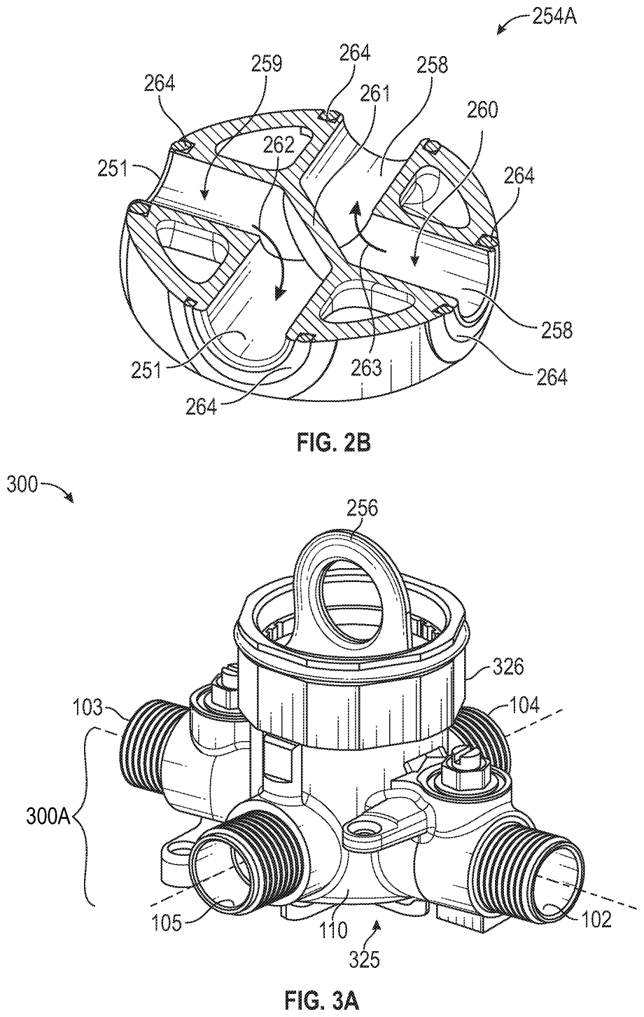

FIG. 2A depicts flush plug 250 according to an embodiment. Visible is inlet/outlet pair 251 (one of two inlet/outlet pairs, the other not visible). Also shown are flush plug handle portion 252, stem portion 253 and flow passageway portion 254. Notches 255 are configured to mate with tabs 108 of rough-in valve 110 of FIG. 1. Notches 255 are configured to provide for about 90 degree rotation positions of flush plug 250 relative to a rough-in valve chamber. Handle portion 252 comprises gripping feature 256. Inlets and outlets comprise grooves 257, configured to receive a gasket configured to form a seal with an interior wall of a rough-in valve chamber.

FIG. 2B shows cross-section 254A of flow passageway portion 254 of flush plug 250 of FIG. 2, according to an embodiment. Visible are first inlet/outlet pair 251 and a second inlet/outlet pair 258. First inlet/outlet pair 251 defines first flow passageway 259 and second inlet/outlet pair 258 defines second flow passageway 260. Passageways 259 and 260 are separated by flow diverter 261 and thus cannot fluidly communicate, i.e. the passageways are not in flow communication and are isolated. In an embodiment, passageway 259 may comprise a water flow path in direction 262 and passageway 260 may comprise a water flow path in direction 263. Flow path direction 262 is opposite that of flow path direction 263. In this embodiment, each inlet is disposed about 90 degrees from each outlet, i.e. a central axis of each inlet is about 90 degrees from a central axis of each outlet. In this embodiment, passageways 259 and 260 are substantially mirror images of each other. Ring-shaped gaskets 264 are present in grooves 257 surrounding each inlet and outlet.

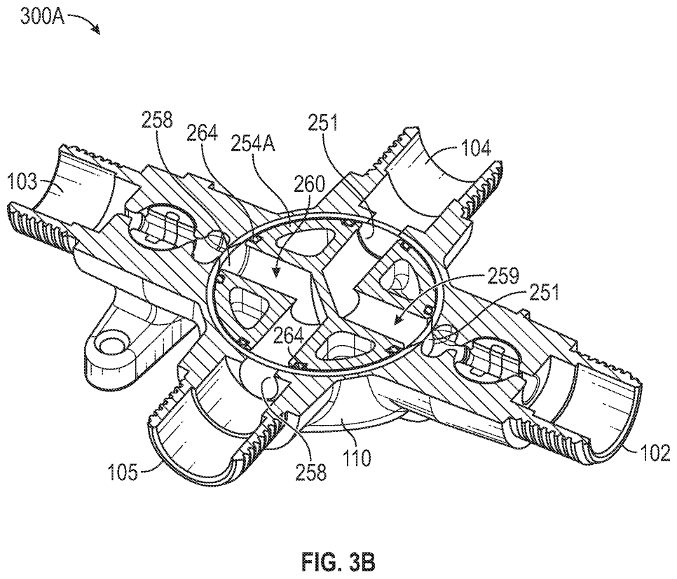

FIG. 3A shows rough-in valve/flush plug assembly 300, according to an embodiment. Flush plug 250 is removably disposed in rough-in valve 110. Visible is handle portion feature 256 of flush plug 250. Assembly 300 is secured with threaded nut 326. Label 325 points to a “back” of assembly 300. The dashed lines represent axes of inlets 102 and 103 and outlets 104 and 105. Cross-section 300A is shown in FIG. 3B.

FIG. 3B shows a front perspective view of cross-section 300A of rough-in valve/flush plug assembly 300, according to an embodiment. Shown are rough-in valve first inlet 102, second inlet 103, first outlet 104, and second outlet 105. First flush plug inlet/outlet pair 251 and first flow passageway 259 are in flow communication with first inlet 102 and first outlet 104 and are configured to be in flow communication with a first fluid supply source and a first plumbing outlet. Second flush plug inlet/outlet pair 258 and second flow passageway 260 are in flow communication with second inlet 103 and second outlet 105 and are configured to be in flow communication with a second fluid supply source and a second plumbing outlet. In an embodiment, passageway 259 is configured to deliver water from a hot water source to a tub outlet and passageway 260 is configured to deliver water from a cold water source to a shower outlet. Upon placing a second rough-in valve/flush plug assembly back-to-back with the one displayed in FIG. 3B, while rotating about a Y axis, 104 and 105 will be in the same position and 102 and 103 will be in opposing positions. If hot and cold water are delivered from the same side to both rough-in valve/flush plug assemblies, one will deliver hot water to a tub outlet and cold water to a shower outlet, and the other will deliver hot water to a shower outlet and cold water to a tub outlet.

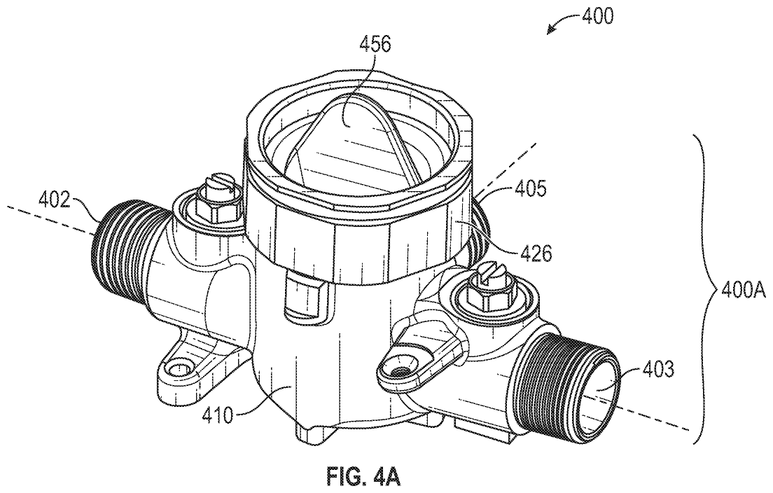

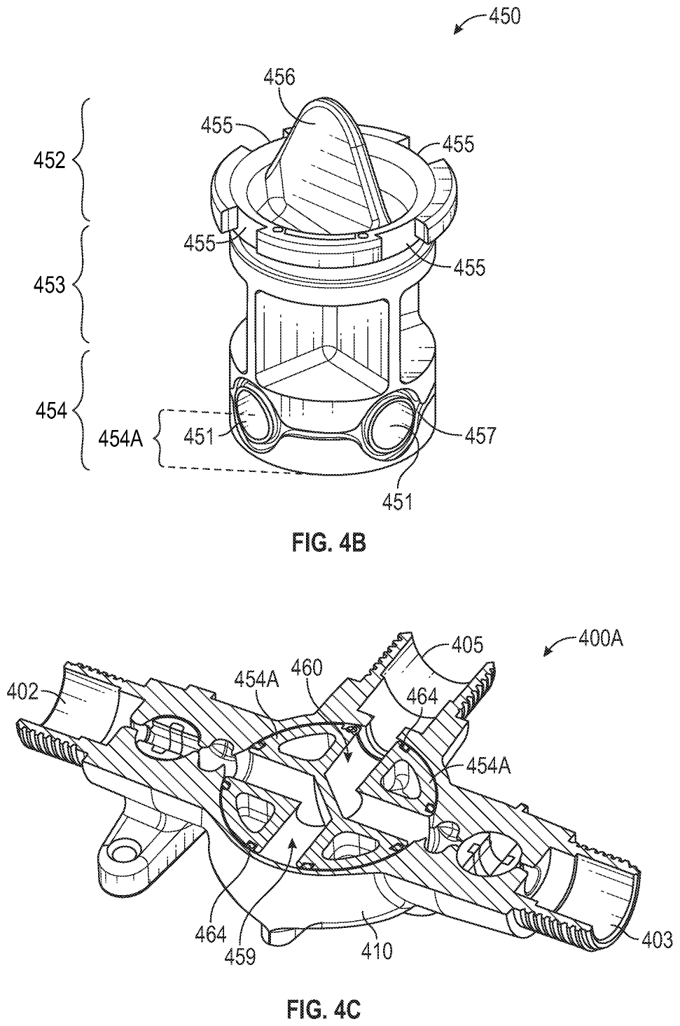

FIG. 4A shows rough-in valve/flush plug assembly 400, according to an embodiment. Shown are rough-in valve first inlet 402, second inlet 403, and outlet 405. Outlet 405 may be in flow communication with a shower outlet. Flush plug 450 is removably disposed in rough-in valve 410. Visible is handle portion 456. Assembly 400 is secured with threaded nut 426. Dashed lines represent axes of inlets 402 and 403 and outlet 405. Cross-section 400A is shown in FIG. 4C.

FIG. 4B depicts flush plug 450 according to an embodiment. Flush plug 450 comprises handle portion 452, stem portion 453, and flow passageway portion 454. Handle portion 452 comprises handle gripping portion 456 and notches 455. Notches 455 are configured to mate with tabs of a rough-in valve and to provide for 90 degree rotation positioning of flush plug 450 relative to a rough-in valve chamber. Shown is inlet/outlet pair 451. Inlets and outlets comprise grooves 457, configured to receive a gasket configured to form a seal with an interior wall of a rough-in chamber. Grooves 457 extend between inlets and outlets in order to receive a gasket comprising ring-shaped sections attached via strut sections.

FIG. 4C shows cross-section 400A of flush plug/rough-in valve assembly 400, according to an embodiment. Cross-section 454A of flush plug 450 is visible. Shown are rough-in valve first inlet 402, second inlet 403, and outlet 405. Flush plug flow passageway 459 is in flow communication with inlet 402 and is a dead-end. Flow passageway 460 is configured to provide flow communication between inlet 403 and outlet 405. Outlet 405 may be in flow communication with a shower outlet. Rotation of flush plug 450 about 90 degrees relative to rough-in valve 410 chamber will provide for flow communication between inlet 402 and outlet 405 via flow passageway 459 and place flow passageway 460 in a dead-end position. Fluid sources in communication with inlets 402 and 403 may be flushed and tested separately. Flow passageways 459 and 460 are isolated and not in flow communication. Inlets 402 and 403 are not in flow communication. A first fluid source and a second fluid source in flow communication with inlet 402 and inlet 403, respectively, are not in flow communication. Gasket 464 is visible.

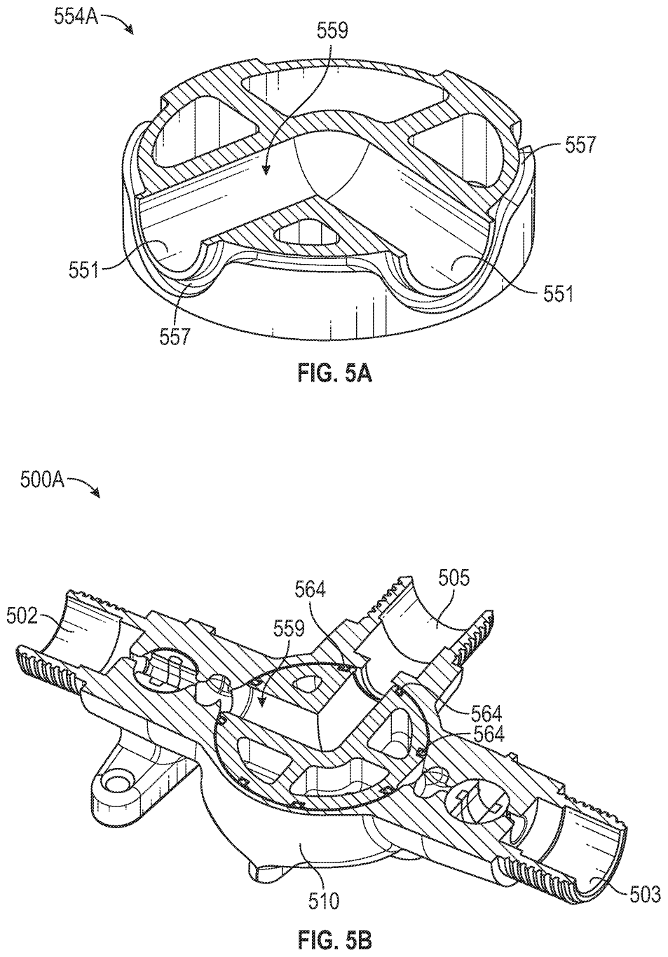

FIG. 5A shows cross-section 554A of a flush plug flow passageway portion, according to an embodiment. The flush plug of FIG. 5A comprises one inlet/outlet pair 551 defining one flow passageway 559. FIG. 5B shows cross-section 500A of a flush plug/rough-in valve assembly. Rough-in valve 510 comprises first inlet 502, second inlet 503 and outlet 505. Flush plug flow passageway 559 is configured to receive fluid flow from inlet 502 and to direct fluid flow to outlet 505. Outlet 505 may be in flow communication with a shower outlet. Rotation of the flush plug of about 90 degrees relative to the rough-in valve will place flow passageway 559 in flow communication with inlet 503 and outlet 505. Thus, in an embodiment, hot and cold water lines can be flushed and tested separately. Gasket 564 is present in ring-shaped grooves 557.

Some rough-in valves are disclosed for example in app. No. PCT/US18/57014, filed Oct. 23, 2018 and published as WO2019/083942 and app. No. PCT/US20/27641 filed Apr. 10, 2020.

An inlet/outlet pair defines a flow passageway, configured to be in flow communication with a first fluid source and a first plumbing outlet, or to be in flow communication with a second fluid source and a first plumbing outlet when the flush plug is disposed in a rough-in valve chamber. In some embodiments, a first plumbing outlet may be a shower outlet. In other embodiments, a first plumbing outlet may be a tub outlet.

Whether a first fluid source or a second fluid source is configured to be in flow communication with a first plumbing outlet will depend on a rotational position of the flush plug in a rough-in valve chamber. In some embodiments, about 90 degree rotation intervals of the flush plug relative to the rough-in valve chamber will determine whether the first fluid source or second fluid source is configured to be in flow communication with a first plumbing outlet.

When a flush plug is positioned in a rough-in valve chamber, the first fluid source and the second fluid source may not be in flow communication. The first and second fluid sources may be flushed and tested separately.

A first inlet/outlet pair defines a first flow passageway and a second inlet/outlet pair defines a second flow passageway. The first flow passageway is configured to be in flow communication with a first fluid supply source and a first plumbing outlet. The second flow passageway is configured to be in flow communication with a second fluid supply source and a second plumbing outlet.

The first and second flow passageways are not in flow communication, that is, they are isolated and no cross-flow between them is possible. In some embodiments, the first and second passageways each comprise about a 90 degree turn (angle) from an inlet to outlet. In some embodiments, the first and second passageways are isolated and separated by a diverter feature (flow diverter).

In some embodiments, the first and second flow passageways may be substantially mirror images of each other. In some embodiments, the first and second flow passageways define a first flow path and a second flow path, respectively, and wherein the first and second flow paths are configured to be opposite each other. For instance, a flow path “up” towards a shower outlet may be considered opposite a flow path “down” towards a tub outlet. In some embodiments, a flush plug may be symmetrical about a plane bisecting the flush plug.

In some embodiments, the first fluid source is a hot water source and the second fluid source is a cold water source. In another embodiment, the first fluid source is a cold water source and the second fluid source is a hot water source.

In some embodiments, the first plumbing outlet is a shower outlet, for example a shower head, and the second plumbing outlet is a tub outlet, for example a tub spout. In another embodiment, the first plumbing outlet is a tub outlet and a second plumbing outlet is a shower outlet.

In some embodiments, first and second fluid sources and first and second plumbing outlets may depend upon a position of a flush plug when disposed in a rough-in valve chamber. In some embodiments, each flush plug inlet and each outlet are positioned about 90 degrees from each other.

In one embodiment, a flush plug/rough-in valve assembly comprising the flush plug inserted into a rough-in valve chamber, a first flow passageway may provide for flow communication between a first fluid source and a first plumbing outlet and a second flow passageway may provide for flow communication between a second fluid source and a second plumbing outlet or to be a dead-end. Upon rotating the flush plug about 90 degrees relative to the rough-in valve chamber, in an embodiment, the first flow passageway may provide for flow communication between a second fluid source and a first plumbing outlet and the second flow passageway may provide for flow communication between a first fluid source and a second plumbing outlet or to be a dead-end.

The flush plug is configured to be removably disposed in a rough-in valve chamber. In some embodiments, a flush plug exterior may be configured to receive one or more gaskets configured to form a seal with an interior chamber surface of a rough-in valve. In some embodiments, an exterior of the flush plug may comprise one or more grooves configured to receive one or more gaskets. In a certain embodiment, a gasket may comprise ring-shaped sections connected via strut sections. In another embodiment a gasket may be ring-shaped. In some embodiments, each flush plug inlet and outlet may comprise a ring-shaped groove surrounding it configured to receive a gasket.

In some embodiments, a flush plug is configured to be positioned in a rough-in valve chamber via an attachment element. One or more attachment elements may ensure the flush plug is placed in a proper position to align flush plug inlets and outlets with rough-in valve inlets and outlets. In some embodiments, attachment elements may comprise one or more of pin/slot attachment elements, notch/tab attachment elements or threaded elements. In a certain embodiment, a flush plug may comprise one or more notches configured to mate with one or more tabs positioned on the rough-in valve. In other embodiments, a notch/tab arrangement may comprise one or more tabs positioned on a flush plug configured to mate with one or more notches positioned on a rough-in valve. In an embodiment, a flush plug may comprise 4 attachment elements substantially equally spaced about a perimeter to provide for 90 degree rotation interval positioning.

In some embodiments, a flush plug may comprise a handle portion, a stem portion, and a flow passageway portion. A flow passageway portion may be substantially circular and may fit snugly into a rough-in valve chamber, and wherein flush plug inlets and outlets will align with rough-in valve inlets and outlets. A handle portion may be visible and accessible when the flush plug is inserted into a rough-in valve chamber. A handle portion may comprise a gripping feature, configured to provide for greater ease for insertion or removal of the flush plug into/out of the rough-in valve chamber. A handle portion may comprise raised textured grips or may comprise a ring feature, each configured to provide leverage for a finger or fingers. A stem portion provides for a desired length of a flush plug.

In some embodiments, a length of a rough-in valve from inlet to inlet is from any of about 100 mm, about 105 mm, about 110 mm, about 120 mm, or about 130 mm to any of about 140 mm, about 150 mm, about 155 mm, about 160 mm, about 170 mm, about 180 mm, or more.

In some embodiments, a height of the rough-in valve from outlet to outlet is from any of about 85 mm, about 90 mm, about 95 mm, about 100 mm, or about 105 mm to any of about 110 mm, about 115 mm, about 120 mm, about 125 mm, about 130 mm, about 135 mm, or more.

In some embodiments, a length of a flush plug, from a bottom (back) edge of a flow passageway portion to a top (front) edge of a handle portion is from any of about 65 mm, about 70 mm, about 75 mm, about 76 mm, about 80 mm or about 85 mm to any of about 90 mm, about 95 mm, about 100 mm, about 105 mm, or more.

In some embodiments, a length (or thickness) of a flow passageway portion may be from any of about 14 mm, about 15 mm, about 16 mm, about 17 mm, about 18 mm or about 19 mm, to any of about 20 mm, about 21 mm, or about 22 mm, or more.

In some embodiments, a diameter of a flow passageway portion may be from any of about 35 mm, about 36 mm, about 37 mm, about 38 mm, about 39 mm or about 40 mm, to any of about 41 mm, about 42 mm, about 43 mm, about 44 mm, about 45 mm, or more.

In some embodiments, a length of a stem portion, from a top edge of a flow passageway portion to a top edge of a stem portion, is from any of about 24 mm, about 25 mm, about 26 mm, about 27 mm, about 28 mm, or about 29 mm, to any of about 30 mm, about 31 mm, about 32 mm, about 33 mm, about 34 mm, about 35 mm, or more.

In large projects like hotels, apartment buildings, and the like, a plurality of rough-in valves may be installed, and wherein they are placed back-to-back in adjoining bathrooms. It is convenient for a plumber to simply rotate a rough-in valve 180 degrees around a Y axis to place it back-to-back with another rough-in valve for an adjoining bathroom, and allowing hot water connections from the same side and cold water connections from the same side. A present rough-in valve comprising a flush plug of the disclosure allows for this. A present flush plug/rough-in valve assembly allows for 90 rotation of a flush plug relative to the rough-in valve, for one of the back-to-back assemblies. This will allow for individual flushing and testing of hot and cold water lines, and for the hot water, for instance, to be directed to a tub spout and for the cold to be directed to a shower outlet, for each case.

Following are some non-limiting embodiments of the disclosure.

In a first embodiment, disclosed is a flush plug for a rough-in valve, wherein the flush plug is configured to be removably disposed in a rough-in valve chamber, and comprises an inlet/outlet pair defining a flow passageway, wherein when disposed in the rough-in valve chamber, in a first flush plug position, the flow passageway is configured to provide flow communication between a first fluid source and a first plumbing outlet, in a second flush plug position, the flow passageway is configured to provide flow communication between a second fluid source and the first plumbing outlet, and the first fluid source and the second fluid source are not in flow communication.

In a second embodiment, disclosed is a flush plug according to the first embodiment, wherein the second flush plug position relative to the first flush plug position is about a 90 degree rotation interval of the flush plug relative to the rough-in valve chamber.

In a third embodiment, disclosed is a flush plug according to the first or second embodiments, comprising a first inlet/outlet pair defining a first flow passageway; and a second inlet/outlet pair defining a second flow passageway; wherein in the first flush plug position, the first flow passageway is configured to provide flow communication between the first fluid source and the first plumbing outlet, and the second flow passageway is configured to be a dead-end or is configured to provide flow communication between the second fluid source and a second plumbing outlet; in the second flush plug position, the first flow passageway is configured to provide flow communication between the second fluid source and the first plumbing outlet, and the second flow passageway is configured to be a dead-end or is configured to provide flow communication between the first fluid source and the second plumbing outlet; and wherein the first and second flow passageways are isolated.

In a fourth embodiment, disclosed is a flush plug according to any of the preceding embodiments, wherein the first fluid source is a hot water source and the second fluid source is a cold water source; or the first fluid source is a cold water source and the second fluid source is a hot water source.

In a fifth embodiment, disclosed is a flush plug according to any of the preceding embodiments, wherein the first plumbing outlet is a shower head and the second plumbing outlet is a tub spout; or the first plumbing outlet is a tub spout and the second plumbing outlet is a shower head.

In a sixth embodiment, disclosed is a flush plug according to any of the preceding embodiments, wherein each inlet and outlet of the inlet/outlet pairs are disposed about 90 degrees from each other.

In a seventh embodiment, disclosed is a flush plug according to any of the preceding embodiments, wherein the flush plug is configured to be positioned in the rough-in valve chamber via one or more attachment elements.

In an eighth embodiment, disclosed is a flush plug according to any of the preceding embodiments, wherein the flush plug is configured to be positioned in the rough-in valve chamber via one or more attachment elements selected from pin/slot attachment elements, a notch/tab elements, pin/hole elements, or threaded elements.

In a ninth embodiment, disclosed is a flush plug according to any of the preceding embodiments, wherein the flush plug is configured to be positioned in the rough-in valve chamber at about 90 degree rotation intervals relative to the rough-in valve chamber.

In a tenth embodiment, disclosed is a flush plug according to any of the preceding embodiments, wherein the first and second flow passageways comprise about a 90 degree angle.

In an eleventh embodiment, disclosed is a flush plug according to any of the preceding embodiments, wherein the first flow passageway defines a first flow path, the second flow passageway defines a second flow path, and wherein the first and second flow paths are configured to be opposite each other.

In a twelfth embodiment, disclosed is a flush plug according to any of the preceding embodiments, wherein the first and second flow passageways are substantially mirror images of each other.

In a thirteenth embodiment, disclosed is a flush plug according to any of the preceding embodiments, wherein the flush plug comprises a handle portion, a stem portion, and a flow passageway portion.

In a fourteenth embodiment, disclosed is a flush plug according to any of the preceding embodiments, wherein the flush plug comprises a handle portion comprising a gripping feature, the gripping feature configured to ease insertion and removal of the flush plug into and from the rough-in valve chamber, respectively.

In a fifteenth embodiment, disclosed is a flush plug according to any of the preceding embodiments, wherein the flush plug comprises one or more grooves configured to receive a gasket, the gasket configured to form a seal with an interior wall of the rough-in valve chamber.

In a sixteenth embodiment, disclosed is a rough-in valve assembly comprising a rough-in valve having a chamber configured to receive a valve manifold or a flush plug; a first valve inlet configured to be in flow communication with a first fluid source; a second valve inlet configured to be in flow communication with a second fluid source; a first valve outlet configured to be in flow communication with the valve chamber and a first plumbing outlet; and the flush plug according to any of embodiments 1 to 15 removably disposed in the chamber.

In a seventeenth embodiment, disclosed is a rough-in valve assembly according to the sixteenth embodiment, comprising a second valve outlet configured to be in flow communication with the valve chamber and a second plumbing outlet.

In an eighteenth embodiment, disclosed is a rough-in valve assembly according to embodiments 16 or 17, wherein the first valve outlet is a shower valve outlet configured to be in flow communication with a shower head and the second valve outlet is a tub valve outlet configured to be in flow communication with a tub spout.

In a nineteenth embodiment, disclosed is a rough-in valve assembly according to any of embodiments 16 to 18, wherein a) the first valve inlet is configured to be in flow communication with a hot water source and the second valve inlet is configured to be in flow communication with a cold water source; or b) the first valve inlet is configured to be in flow communication with a cold water source and the second valve inlet is configured to be in flow communication with a hot water source.

In a twentieth embodiment, disclosed is a plumbing system comprising first and second rough-in valve assemblies according to any of embodiments 16 to 19, wherein one of the rough-in valves is rotated about 180 degrees about a Y axis in order to position the two rough-in valves back-to-back, and wherein the two rough-in valves are configured to receive the first fluid source from the same side and configured to receive the second fluid source from the same side, and the flush plug of the second rough-in valve assembly is positioned at about a 90 rotation interval relative to the flush plug of the first rough-in valve assembly.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through. The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

All U.S. patent applications, published patent applications and patents referred to herein are hereby incorporated by reference.

1. A flush plug for a rough-in valve,
wherein the flush plug is configured to be removably disposed in a rough-in valve chamber, and comprises an inlet/outlet pair defining a flow passageway,
wherein when disposed in the rough-in valve chamber,
in a first flush plug position, the flow passageway is configured to provide flow communication between a first fluid source and a first plumbing outlet,
in a second flush plug position, the flow passageway is configured to provide flow communication between a second fluid source and the first plumbing outlet, and
the first fluid source and the second fluid source are not in flow communication.

2. The flush plug according to claim 1, wherein the second flush plug position relative to the first flush plug position is about a 90 degree rotation interval of the flush plug relative to the rough-in valve chamber.

3. The flush plug according to claim 1, comprising
a first inlet/outlet pair defining a first flow passageway; and
a second inlet/outlet pair defining a second flow passageway;
wherein
in the first flush plug position, the first flow passageway is configured to provide flow communication between the first fluid source and the first plumbing outlet, and the second flow passageway is configured to be a dead-end or is configured to provide flow communication between the second fluid source and a second plumbing outlet;
in the second flush plug position, the first flow passageway is configured to provide flow communication between the second fluid source and the first plumbing outlet, and the second flow passageway is configured to be a dead-end or is configured to provide flow communication between the first fluid source and the second plumbing outlet; and
wherein the first and second flow passageways are isolated.

4. The flush plug according to claim 1, wherein
the first fluid source is a hot water source and the second fluid source is a cold water source; or
the first fluid source is a cold water source and the second fluid source is a hot water source.

5. The flush plug according to claim 3, wherein
the first plumbing outlet is a shower head and the second plumbing outlet is a tub spout; or
the first plumbing outlet is a tub spout and the second plumbing outlet is a shower head.

6. The flush plug according to claim 3, wherein each inlet and outlet of the inlet/outlet pairs are disposed about 90 degrees from each other.

7. The flush plug according to claim 3, wherein the first and second flow passageways comprise about a 90 degree angle.

8. The flush plug according to claim 3, wherein the first flow passageway defines a first flow path, the second flow passageway defines a second flow path, and wherein the first and second flow paths are configured to be opposite each other.

9. The flush plug according to claim 3, wherein the first and second flow passageways are substantially mirror images of each other.

10. The flush plug according to claim 1, wherein the flush plug is configured to be positioned in the rough-in valve chamber via one or more attachment elements.

11. The flush plug according to claim 1, wherein the flush plug is configured to be positioned in the rough-in valve chamber via one or more attachment elements selected from a group consisting of pin/slot attachment elements, a notch/tab elements, pin/hole elements, and threaded elements.

12. The flush plug according to claim 1, wherein the flush plug is configured to be positioned in the rough-in valve chamber at about 90 degree rotation intervals relative to the rough-in valve chamber.

13. The flush plug according to claim 1, wherein the flush plug comprises one or more grooves configured to receive a gasket, the gasket configured to form a seal with an interior wall of the rough-in valve chamber.

14. The flush plug according to claim 1, wherein the flush plug comprises a handle portion, a stem portion, and a flow passageway portion.

15. The flush plug according to claim 1, wherein the flush plug comprises a handle portion comprising a gripping feature, the gripping feature configured to ease insertion and removal of the flush plug into and out of the rough-in valve chamber, respectively.

16. A rough-in valve assembly comprising
a rough-in valve having a chamber configured to receive a valve manifold or a flush plug;
a first valve inlet configured to be in flow communication with a first fluid source;
a second valve inlet configured to be in flow communication with a second fluid source;
a first valve outlet configured to be in flow communication with the valve chamber and a first plumbing outlet; and
the flush plug according to claim 1 removably disposed in the chamber.

17. The rough-in valve assembly according to claim 16, comprising
a second valve outlet configured to be in flow communication with the valve chamber and a second plumbing outlet.

18. The rough-in valve assembly according to claim 17, wherein the first valve outlet is a shower valve outlet configured to be in flow communication with a shower head and the second valve outlet is a tub valve outlet configured to be in flow communication with a tub spout.

19. The rough-in valve assembly according to claim 16, wherein
a) the first valve inlet is configured to be in flow communication with a hot water source and the second valve inlet is configured to be in flow communication with a cold water source;
or
b) the first valve inlet is configured to be in flow communication with a cold water source and the second valve inlet is configured to be in flow communication with a hot water source.

20. A plumbing system comprising first and second rough-in valve assemblies according to claim 16,
wherein one of the rough-in valves is rotated about 180 degrees about a Y axis in order to position the two rough-in valves back-to-back, and
wherein
the two rough-in valves are configured to receive the first fluid source from the same side and configured to receive the second fluid source from the same side, and
the flush plug of the second rough-in valve assembly is positioned at about a 90 rotation interval relative to the flush plug of the first rough-in valve assembly.
